(19) United States
(12) Patent Application Publication
(10) Pub. No.: US 2018/0060887 A1
(43) Pub. Date: Mar. 1, 2018

(54) BRAND EQUITY PREDICTION

(71) Applicant: INTERNATIONAL BUSINESS MACHINES CORPORATION, Armonk, NY (US)

(72) Inventors: Raphael EZRY, New York, NY (US); Munish GOYAL, Yorktown Heights, NY (US); Jingzi TAN, Chicago, IL (US)

(21) Appl. No.: 15/251,552

(22) Filed: Aug. 30, 2016

(51) Int. Cl. G06Q 30/02; G06Q 10/06

(52) U.S. Cl. CPC G06Q 30/0202; G06Q 10/06375; G06Q 30/0201

(57) ABSTRACT

Methods, computer program products, and systems are presented. The methods include, for instance: evaluating a brand value as a function of numerous parameters as formulated by brand value dynamics, and by use of input data for accurate prediction of the brand value. A brand equity is estimated based on the brand value and brand values of all brands competing in the market.

### TECHNICAL FIELD

The present disclosure relates to predictive modeling and analytics, and more particularly to methods, computer program products, and systems for predicting brand value, brand equity of a branded product and sensitivity of the brand equity to market influences.

### BACKGROUND

In conventional brand evaluation, value of a brand may be determined by various actions of a brand owner as well as competitors in the same market over time. As market conditions dynamically change, information on how brand value/equity would react to such market conditions may be valuable for a long-term business strategy.

### SUMMARY

The shortcomings of the prior art are overcome, and additional advantages are provided, through the provision, in one aspect, of a method. The method for predicting a brand equity includes, for example: obtaining, by one or more processor of a computer, inputs including marketing data, reach estimates, a launch date, and historic sales data, respectively of each brand in one or more brands; evaluating a brand value of a current brand from the one or more brands, at time t, as a function of parameters including a retention rate of the brand value of the current brand, an efficiency of marketing and product reach of the current brand, and a sensitivity of the current brand to a marketing spend, based on the brand value at time (t−1), and the marketing data and the reach estimates from the inputs; estimating the brand equity at time t based on the evaluated brand value of the current brand and brand values estimated for respective brand in the one or more brands, and producing the brand equity to a user.

Additional features are realized through the techniques set forth herein. Other embodiments and aspects, including but not limited to computer program product and system, are described in detail herein and are considered a part of the claimed invention.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 depicts a system for predicting brand equity and sensitivity, in accordance with one or more embodiments set forth herein;

FIG. 2 depicts brand value dynamics as formulated to estimate a brand value V(T) at time T, in accordance with one or more embodiments set forth herein;

FIG. 3 depicts a flowchart for the brand equity prediction engine, in accordance with one or more embodiments set forth herein;

FIG. 4 depicts a brand value formula, a brand equity formula, and a sum of squared errors formula as used in the process of the brand equity prediction engine, in accordance with one or more embodiments set forth herein;

FIG. 5 depicts an equity sensitivity graph and a sales response graph, in accordance with one or more embodiments set forth herein;

FIG. 6 depicts a sales impact graph exhibiting varied equity sensitivities of multiple brands, in accordance with one or more embodiments set forth herein;

FIG. 7 depicts a cloud computing node according to an embodiment of the present invention;

FIG. 8 depicts a cloud computing environment according to an embodiment of the present invention; and

FIG. 9 depicts abstraction model layers according to an embodiment of the present invention.

### DETAILED DESCRIPTION

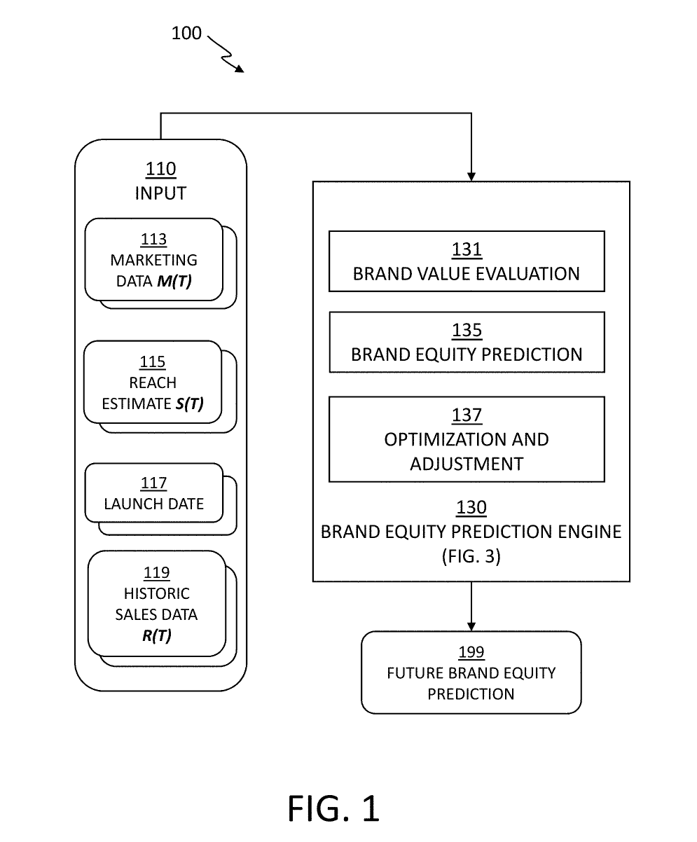

FIG. 1 depicts a system 100 for predicting brand equity and sensitivity, in accordance with one or more embodiments set forth herein.

The system 100 for predicting brand equity and sensitivity includes a brand equity prediction engine 130 that obtains input data 110 and produces a future brand equity prediction 199.

The input data 110 includes marketing data M(T) 113, reach estimates S(T) 115, one or more launch dates 117, and historic sales data R(T) 119. The marketing data M(T) 113 are marketing expenditures such as advertising at time T, which is presumed to influence the market value favorably. The reach estimates S(T) 115 are numbers of units sold at time T, which is also presumed to positively impact the market value of a branded product. The one or more launch dates 117 are respective launch dates of respective brands. The historic sales data R(T) 119 is sales data at time T, which is utilized to check estimations/predictions for accuracy and to optimize estimations/predictions.

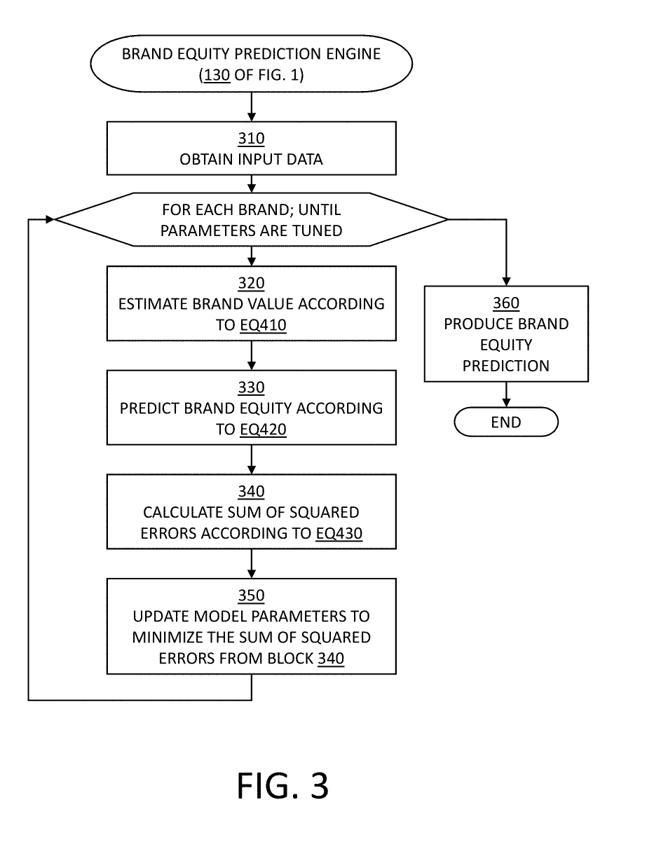

The brand equity prediction engine 130 includes a brand value evaluation process 131, a brand equity prediction process 135, and an optimization and adjustment process 137. The components 131, 135, and 137 of the brand equity prediction engine 130 are abstracted functional components, and may or may not be implemented as an individual component, depending on embodiments of the present invention. Detailed operations of the brand equity prediction engine 130 are presented in FIG. 3 and corresponding description.

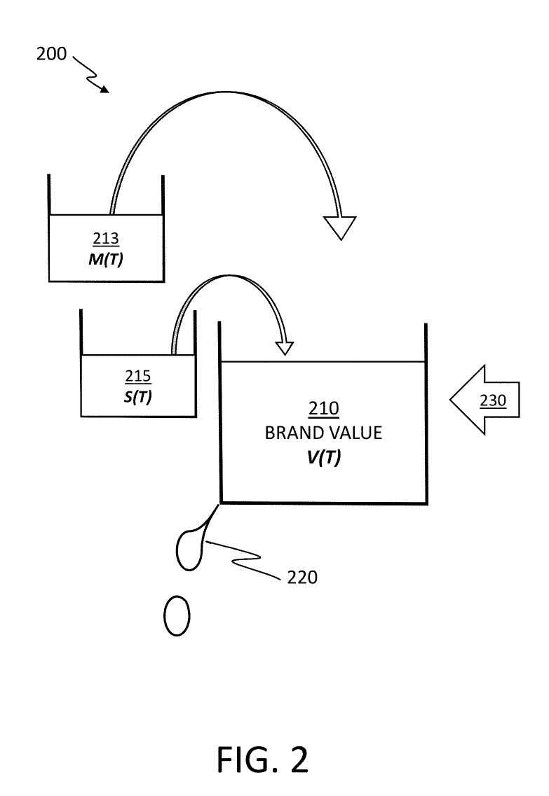

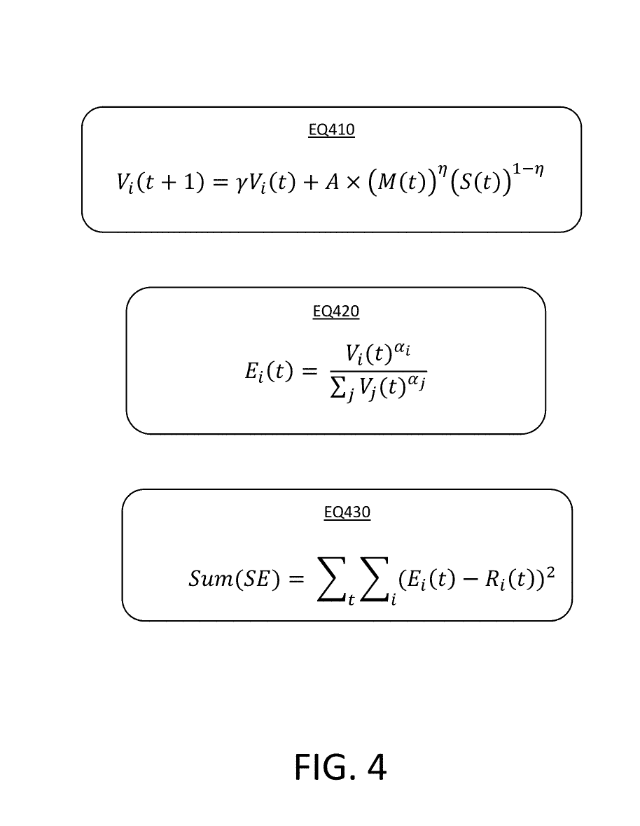

A value of a brand is built over time through actions of various actors in the market. A brand owner may advertise and/or otherwise promote the brand, wherein the value of the brand is expected to increase. Also if owners of competing brands promote the competing brands, the brand may lose value as a reaction. Other market events such as newly discovered medicinal effect and/or safety issues of the branded product as well as the competing products may also increase or decrease the brand value. In this specification, a brand corresponds to a product in one-to-one relationship. Accordingly, for the purpose of the brand value evaluation and the brand equity prediction, marketing data M(T) 113 and the historic sales data R(T) 119 are respectively for a single brand subject to analysis. Also, terms estimation, evaluation, and prediction are used interchangeably to indicate a quantification of future instances of the brand value and/or the brand equity other than actual values or historical data. In this specification, the term brand value indicates a monetary assessment of a brand, the term brand equity indicates a ratio of retained brand value over time, and the term sensitivity, also referred to as equity sensitivity, indicates a quantified level of impact on the brand equity as influenced by various market actions. Details of brand value dynamics are presented in FIG. 2 and corresponding descriptions. Also, details on formulation of a brand value and a brand equity are presented in FIG. 4 and corresponding descriptions.

FIG. 2 depicts brand value dynamics 200 as formulated to estimate a brand value V(T) 210 at time T, in accordance with one or more embodiments set forth herein.

The brand value dynamics 200 depicts a first bucket containing the brand value V(T) 210 at time T, a second bucket containing marketing data M(T) 213 at time T, and a third bucket containing reach estimates S(T) 215 at time T. The M(T) 213 bucket and the S(T) 215 bucket are poured into the brand value V(T) 210 bucket, indicating added marketing spend and added market reach would contribute to increase of the brand value. A leak 220 from the brand value V(T) 210 bucket represents a gradual loss of the brand value V(T) 210 over time as consumers do not remember the brand any longer. An event 230 may shake the brand value V(T) 210 bucket and cause a loss of the brand value, or may increase the brand value by pouring brand value losses from competing brands, that is, leaks from other brand value buckets, into the brand value V(T) 210 bucket.

FIG. 3 depicts a flowchart for the brand equity prediction engine 130 of FIG. 1, and FIG. 4 depicts a brand value formula EQ410, a brand equity formula EQ420, and a sum of squared errors formula EQ430 as used in the process of the brand equity prediction engine 130, in accordance with one or more embodiments set forth herein.

In block 310, the brand equity prediction engine 130 obtains input including marketing data M(T), reach estimates S(T), one or more launch dates of respective brands, and historic sales data R(T). Then the brand equity prediction engine 130 proceeds with block 320.

Blocks 320 through 350 are iterated for each brand subject to analysis, as represented by the input obtained in block 310.

In block 320, the brand equity prediction engine 130 estimates the value of a current brand i according to the brand value formula EQ410 of FIG. 4, which calculates a brand value at time (t+1) as a sum of carryover brand value at time t and a mathematical production of new value as created by a marketing spend M(T) and a product reach S(T), wherein gamma (γ) represents a brand value retention rate, A represents marketing and reach efficiency, eta (η) represents sensitivity of the brand value to the marketing spend M(T), as obtained from block 310, and the product reach S(T) represents a number of units sold over a unit time, identical to the reach estimates obtained from block 310. Initial brand value of the current brand i at time t=0, as provided by the launch dates of the input, is represented as V₀. Then the brand equity prediction engine 130 proceeds with block 330.

In block 330, the brand equity prediction engine 130 estimates the brand equity of the current brand i according to the brand equity formula EQ420 of FIG. 4, wherein the brand equity of the current brand i at time t, represented by Eᵢ(t), is calculated as a ratio of Vᵢ(t)^{α}^{ᵢ}, the brand value of the current brand i at time t to the αᵢ-th power, of to ΣⱼVⱼ(t)^{α}^{ⱼ}, a sum of brand values of all brands j at time t to the αⱼ-th power. αᵢ and αⱼ, represent elasticity rates of the brand value for brand i and brand j, respectively. Then the brand equity prediction engine 130 proceeds with block 340.

In block 340, the brand equity prediction engine 130 calculates a sum of squared errors, Sum(SE), to validate the brand value and the brand equity estimated in blocks 320 and 330, according to the sum of squared errors formula EQ430 of FIG. 4, wherein respective differences between the brand equity of the current brand i at time t, Eᵢ(t), and the historical sales data of the current brand i at time t, Rᵢ(t), are squared and added for all brands for each time unit. Then the brand equity prediction engine 130 proceeds with block 350.

In block 350, the brand equity prediction engine 130 updates model parameters including γ, A, V₀, η, and α to minimize the sum of squared errors, Sum(SE), from block 340. If the model parameters for the current brand i are not acceptable because Sum(SE) is not sufficiently minimized, then the brand equity prediction engine 130 loops back to block 320 to apply the model parameters updated in block 350 for the current brand i. If Sum(SE) is acceptable in block 340 and accordingly, the model parameters for the current brand i do not need to be updated, then the brand equity prediction engine 130 loops back to block 320 to process a next brand. If all brands subject to analysis had been processed, then the brand equity prediction engine 130 proceeds with block 360.

In block 360, the brand equity prediction engine 130 produces predicted brand equities respective to each brand to a user. Then the brand equity prediction engine 130 terminates processing the input.

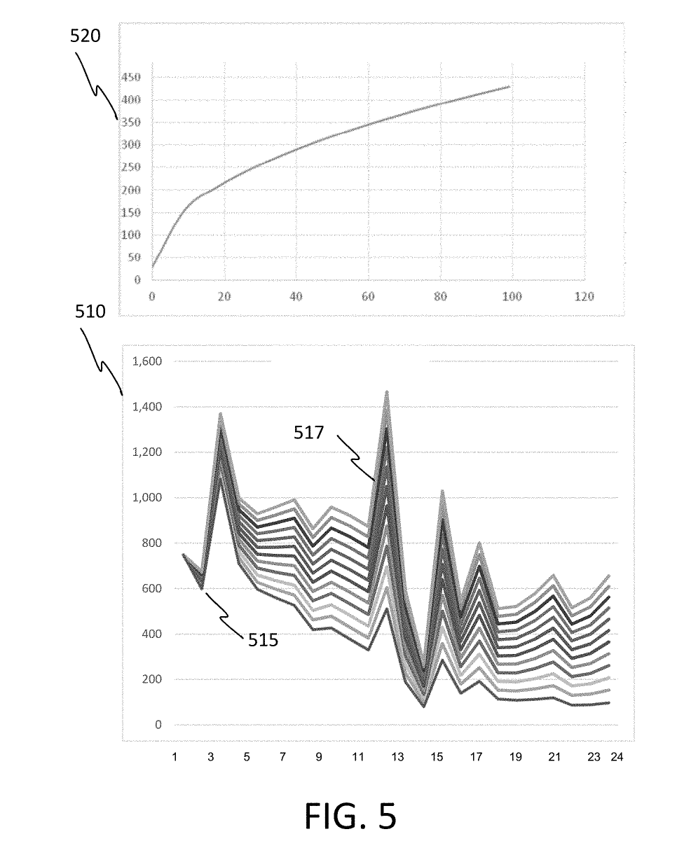

FIG. 5 depicts a sensitivity graph 510 and a sales response graph 510, in accordance with one or more embodiments set forth herein.

Line 515 at the bottom of all lines in the equity sensitivity graph 510 represents a carryover brand equity. For example, for a case in which the brand owner stops marketing effort at time T, the brand equity prediction engine 130 sets Mᵢ(t)=0, and Mⱼ(t)=Mⱼ(T) where t>T, to estimate the brand value and a corresponding brand equity, in blocks 320 and 330 of FIG. 3. The sensitivity of the brand equity to the marketing spend input M(t) is predicted as shown in line 515 with the zero marketing spend configuration.

The equity sensitivity graph 510 shows lines respectively representing brand equity predictions in ten percent (10%) changes with the marketing spend M(t). As noted line 515 represents the carryover brand equity without any marketing effort. Line 517 above all lines represent a brand equity when the brand is marketed the most with the marketing spend at one hundred percent (100%). In another example, wherein the brand owner changes marketing spend in ten percent units at time T, the brand equity prediction engine 130 sets Mᵢ(t)=(1+0.1×x)×Mᵢ(T) and Mⱼ(t)=Mⱼ(T), where t>T.

The sales response graph 520 exhibits the number of predicted sales as a response to the changes in the marketing spend M(t). For a first twenty percent increase of the marketing spend on x-axis, the sales is predicted to increase by approximately 180 units, from 35 to 215 on y-axis. For a next twenty percent increase of the marketing spend, the sales is predicted to increase by approximately 70 units, from 215 to 285, and so on. When the marketing spend increases from eighty percent to one hundred percent, the sales is predicted to increase by approximately 35 units, from 395 to 430. As noted, instances of eta (η) representing sensitivity of the brand value to the marketing spend M(T) may be derived from sales responses as shown in sales response graph 520.

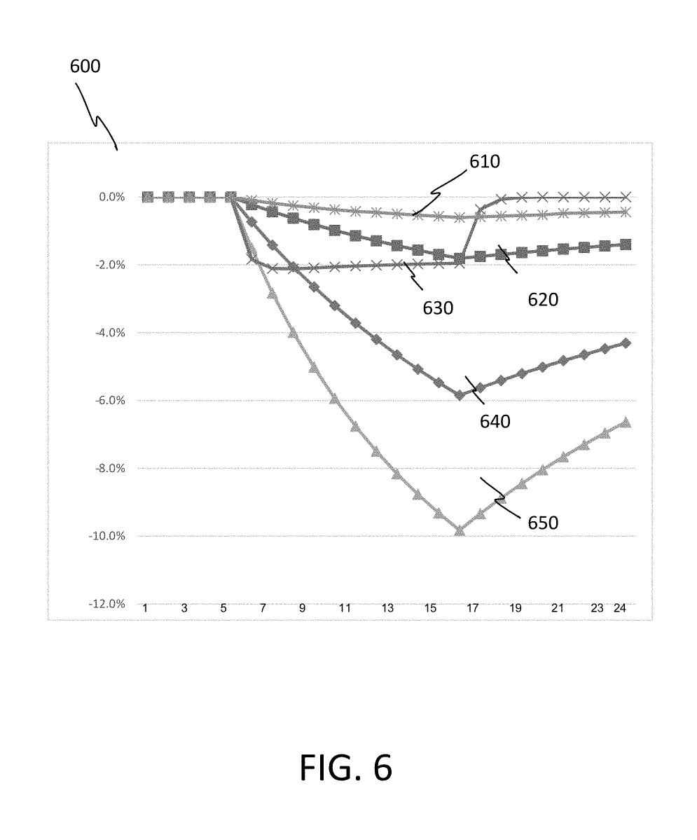

FIG. 6 depicts a sales impact graph 600 exhibiting varied equity sensitivities of multiple brands, in accordance with one or more embodiments set forth herein.

Lines 610, 620, 630, 640, and 650 of the sales impact graph 600 present respective sales changes in five brands, responding to a marketing spend M₁ increase of one hundred percent for ten months, from Month 5 to Month 15 on x-axis, by a first competitor, represented by line 610, amongst competitors. The brand equity prediction engine 130 sets Mᵢ(t)=Mᵢ(T), where t>T, and Mⱼ(t)=Mⱼ(T), where t>T, for all other competitors j not equal to 1. A second competitor, represented by line 620, also increased its marketing spend M₂ one hundred percent. A third competitor, represented by line 630, increased its marketing spend M₃ soon after experiencing a sharp decrease in sales. A fourth competitor and a fifth competitor, represented by line 640 and 650, respectively, did not increase its respective marketing spend, M₄ and M₅, and experienced significant losses in sales during the period of other competitors marketing boost.

Certain embodiments of the present invention may offer various technical computing advantages, including formulation of brand value and brand equity as a function of a brand value retention rate, a marketing and reach efficiency, initial brand value and a sensitivity to marketing spend. Prediction by formulations are validated by use of historical sales data and parameters are iteratively adjusted to minimize a sum of squared errors for optimized prediction of the brand value and the brand equity. Further, sensitivity of the brand value to market events are also predicted by use of input manipulation based on various market scenarios. The brand value and equity predictions may be made more efficiently by use of a cloud computing environment servicing multiple brand owners in need of predicted brand value and equity information for business purposes such as designing of marketing strategies. As the scale of input data may be massive and the market events affecting the brand value and equity are numerous in types, the embodiments of the present invention may provide a timely and efficient analytical services with minimal computing resources by use of effective modeling and optimization.

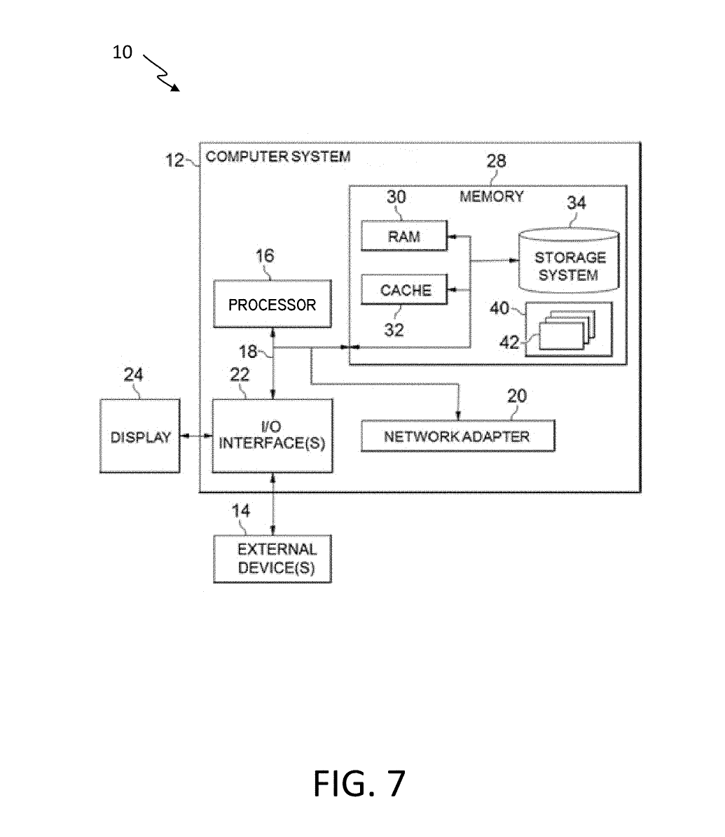

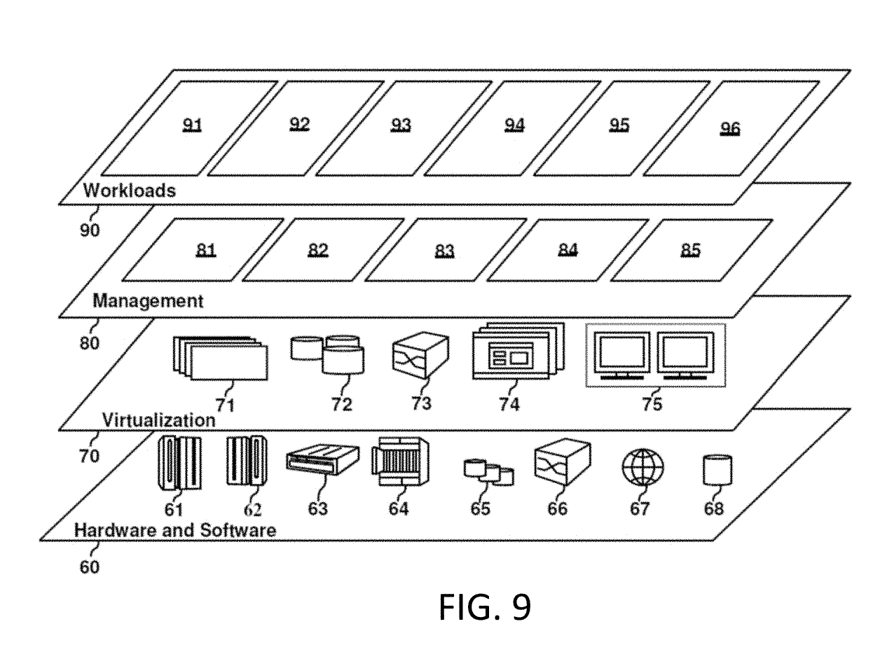

FIGS. 7-9 depict various aspects of computing, including a computer system and cloud computing, in accordance with one or more aspects set forth herein.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 7, a schematic of an example of a computer system/cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system 12, which is operational with numerous other general purpose or special purpose computing system environments or configurations. Examples of well-known computing systems, environments, and/or configurations that may be suitable for use with computer system 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system 12 may be described in the general context of computer system-executable instructions, such as program processes, being executed by a computer system. Generally, program processes may include routines, programs, objects, components, logic, data structures, and so on that perform particular tasks or implement particular abstract data types. Computer system 12 may be practiced in distributed cloud computing environments where tasks are performed by remote processing devices that are linked through a communications network. In a distributed cloud computing environment, program processes may be located in both local and remote computer system storage media including memory storage devices.

As shown in FIG. 7, computer system 12 in cloud computing node 10 is shown in the form of a general-purpose computing device. The components of computer system 12 may include, but are not limited to, one or more processors 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system 12 typically includes a variety of computer system readable media. Such media may be any available media that is accessible by computer system 12, and it includes both volatile and non-volatile media, removable and non-removable media.

System memory 28 can include computer system readable media in the form of volatile memory, such as random access memory (RAM) 30 and/or cache memory 32. Computer system 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program processes that are configured to carry out the functions of embodiments of the invention.

One or more program 40, having a set (at least one) of program processes 42, may be stored in memory 28 by way of example, and not limitation, as well as an operating system, one or more application programs, other program processes, and program data. Each of the operating system, one or more application programs, other program processes, and program data or some combination thereof, may include an implementation of the brand equity prediction engine 130 of FIG. 1. Program processes 42, as in the flowchart of FIG. 3, describing processes of the brand equity prediction engine 130, generally carry out the functions and/or methodologies of embodiments of the invention as described herein.

Computer system 12 may also communicate with one or more external devices 14 such as a keyboard, a pointing device, a display 24, etc.; one or more devices that enable a user to interact with computer system 12; and/or any devices (e.g., network card, modem, etc.) that enable computer system 12 to communicate with one or more other computing devices. Such communication can occur via Input/Output (I/O) interfaces 22. Still yet, computer system 12 can communicate with one or more networks such as a local area network (LAN), a general wide area network (WAN), and/or a public network (e.g., the Internet) via network adapter 20. As depicted, network adapter 20 communicates with the other components of computer system 12 via bus 18. It should be understood that although not shown, other hardware and/or software components could be used in conjunction with computer system 12. Examples, include, but are not limited to: microcode, device drivers, redundant processing units, external disk drive arrays, RAID systems, tape drives, and data archival storage systems, etc.

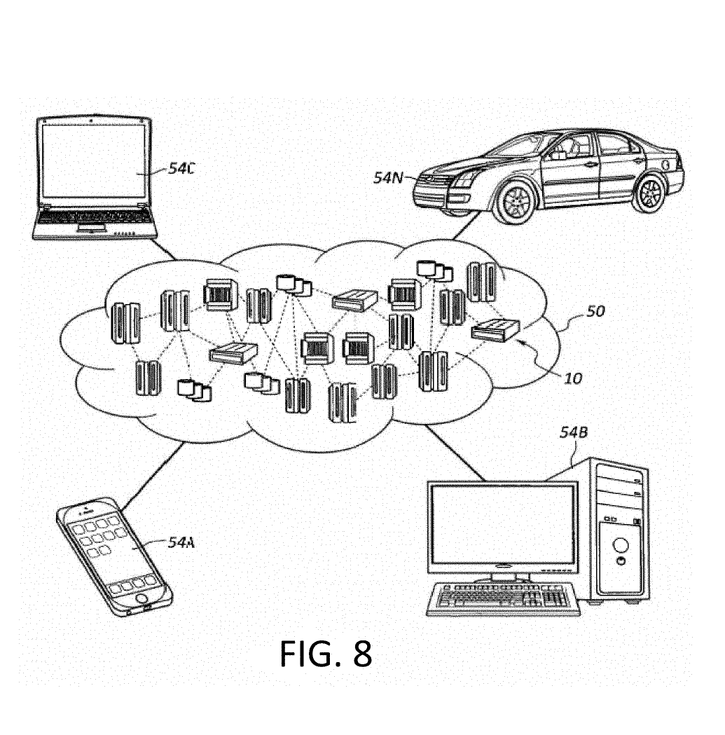

Referring now to FIG. 8, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 running one or more instances of the brand equity prediction engine 130 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 7 are intended to be illustrative only and that computing nodes 10 and cloud computing environment 50 can communicate with any type of computerized device over any type of network and/or network addressable connection (e.g., using a web browser).

Referring now to FIG. 8, a set of functional abstraction layers provided by cloud computing environment 50 (FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and processing components for the brand equity prediction engine 96, as described herein. The processing components 96 can be understood as one or more program 40 described in FIG. 4.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description set forth herein has been presented for purposes of illustration and description, but is not intended to be exhaustive or limited to the form disclosed. Many modifications and variations will be apparent to those of ordinary skill in the art without departing from the scope and spirit of the disclosure. The embodiment was chosen and described in order to best explain the principles of one or more aspects set forth herein and the practical application, and to enable others of ordinary skill in the art to understand one or more aspects as described herein for various embodiments with various modifications as are suited to the particular use contemplated.

What is claimed is:

1. A computer implemented method for predicting a brand equity, comprising:
obtaining, by one or more processor of a computer, inputs including marketing data, reach estimates, a launch date, and historic sales data, respectively of each brand in one or more brands;
evaluating a brand value of a current brand from the one or more brands, at time t, as a function of parameters including a retention rate of the brand value of the current brand, an efficiency of marketing and product reach of the current brand, and a sensitivity of the current brand to a marketing spend, based on the brand value at time (t−1), and the marketing data and the reach estimates from the inputs;
estimating the brand equity at time t based on the evaluated brand value of the current brand and brand values estimated for respective brand in the one or more brands, and
producing the brand equity to a user.

2. The computer implemented method of claim 1, further comprising:
calculating a sum of squared errors at all points of time for all of the one or more brands based on estimated brand equities at all points of time for all of the one or more brands and respective historic sales data for all of the one or more brands.

3. The computer implemented method of claim 2, further comprising:
responsive to determining that the sum of squared errors from the calculating is greater than a preconfigured limit, updating the parameters to new parameters in order to minimize the calculated sum of squared errors, indicating that the brand equity may be more accurately estimated pursuant to the historic sales data from the inputs; and
iterating the evaluating the brand value, the estimating the brand equity, and the calculating the sum of squared errors, by use of the new parameters from the updating the parameters.

4. The computer implemented method of claim 1, the evaluating the brand value comprising:
calculating a carryover brand value from time (t−1) as a mathematical product of the retention rate of the brand value of the current brand and the brand value of the current brand at time (t−1);
calculating a newly generated brand value as a function of the efficiency of marketing and product reach of the current brand, the sensitivity of the current brand to the marketing spend, the marketing data of the current brand, and the reach estimates of the current brand; and
calculating the brand value at time t by adding the carryover brand value and the newly generated brand value.

5. The computer implemented method of claim 4, wherein the evaluating the brand value utilizes a formula Vᵢ(t+1)=γVᵢ(t)+A×(M(t))^{η}(S(t))^{1-η}, wherein Vᵢ(t+1) represents the brand value of the current brand i at time (t+1), γVᵢ(t) represents the carryover brand value from time t, and A×(M(t))^{η}(S(t))^{1-η} represents the newly generated brand value at time t.

6. The computer implemented method of claim 1, the estimating the brand equity comprising:
calculating the brand equity as a ratio of the evaluated brand value of the current brand at time t to a sum of brand values at time t estimated for respective brand in the one or more brands.

7. The computer implemented method of claim 6, wherein the estimating the brand equity utilizes a formula
$${E}_{i} ( t ) = \frac{{{V}_{i} ( t )}^{{α}_{i}}}{{Σ}_{j} {{V}_{j} ( t )}^{{α}_{j}}} ,$$
wherein Vᵢ(t)^{α}^{ᵢ} represents the evaluated brand value of the current brand at time t to the αᵢ-th power, and ΣⱼVⱼ(t)^{α}^{ⱼ} represents the sum of estimated brand values to the αⱼ-th power at time t for respective brands in the one or more brands.

8. A computer program product comprising:
a computer readable storage medium readable by one or more processor and storing instructions for execution by the one or more processor for performing a method for predicting a brand equity, comprising:
obtaining, by the one or more processor, inputs including marketing data, reach estimates, a launch date, and historic sales data, respectively of each brand in one or more brands;
evaluating a brand value of a current brand from the one or more brands, at time t, as a function of parameters including a retention rate of the brand value of the current brand, an efficiency of marketing and product reach of the current brand, and a sensitivity of the current brand to a marketing spend, based on the brand value at time (t−1), and the marketing data and the reach estimates from the inputs;
estimating the brand equity at time t based on the evaluated brand value of the current brand and brand values estimated for respective brand in the one or more brands, and
producing the brand equity to a user.

9. The computer program product of claim 8, further comprising:
calculating a sum of squared errors at all points of time for all of the one or more brands based on estimated brand equities at all points of time for all of the one or more brands and respective historic sales data for all of the one or more brands.

10. The computer program product of claim 9, further comprising:
responsive to determining that the sum of squared errors from the calculating is greater than a preconfigured limit, updating the parameters to new parameters in order to minimize the calculated sum of squared errors, indicating that the brand equity may be more accurately estimated pursuant to the historic sales data from the inputs; and
iterating the evaluating the brand value, the estimating the brand equity, and the calculating the sum of squared errors, by use of the new parameters from the updating the parameters.

11. The computer program product of claim 8, the evaluating the brand value comprising:
calculating a carryover brand value from time (t−1) as a mathematical product of the retention rate of the brand value of the current brand and the brand value of the current brand at time (t−1);
calculating a newly generated brand value as a function of the efficiency of marketing and product reach of the current brand, the sensitivity of the current brand to the marketing spend, the marketing data of the current brand, and the reach estimates of the current brand; and
calculating the brand value at time t by adding the carryover brand value and the newly generated brand value.

12. The computer program product of claim 11, wherein the evaluating the brand value utilizes a formula Vᵢ(t+1)=γVᵢ(t)+A×(M(t))^{η}(S(t))^{1-η}, wherein Vᵢ(t+1) represents the brand value of the current brand i at time (t+1), γVᵢ(t) represents the carryover brand value from time t, and A×(M(t))^{η}(S(t))^{1-η} represents the newly generated brand value at time t.

13. The computer program product of claim 8, the estimating the brand equity comprising:
calculating the brand equity as a ratio of the evaluated brand value of the current brand at time t to a sum of brand values at time t estimated for respective brand in the one or more brands.

14. The computer program product of claim 13, wherein the estimating the brand equity utilizes a formula
$${E}_{i} ( t ) = \frac{{{V}_{i} ( t )}^{{α}_{i}}}{{Σ}_{j} {{V}_{j} ( t )}^{{α}_{j}}} ,$$
wherein Vᵢ(t)^{α}^{ᵢ} represents the evaluated brand value of the current brand at time t to the αᵢ-th power, and ΣⱼVⱼ(t)^{α}^{ⱼ} represents the sum of estimated brand values to the αⱼ-th power at time t for respective brands in the one or more brands.

15. A system comprising:
a memory;
one or more processor in communication with memory; and
program instructions executable by the one or more processor via the memory to perform a method for predicting a brand equity, comprising:
obtaining, by the one or more processor, inputs including marketing data, reach estimates, a launch date, and historic sales data, respectively of each brand in one or more brands;
evaluating a brand value of a current brand from the one or more brands, at time t, as a function of parameters including a retention rate of the brand value of the current brand, an efficiency of marketing and product reach of the current brand, and a sensitivity of the current brand to a marketing spend, based on the brand value at time (t−1), and the marketing data and the reach estimates from the inputs;
estimating the brand equity at time t based on the evaluated brand value of the current brand and brand values estimated for respective brand in the one or more brands, and
producing the brand equity to a user.

16. The system of claim 15, further comprising:
calculating a sum of squared errors at all points of time for all of the one or more brands based on estimated brand equities at all points of time for all of the one or more brands and respective historic sales data for all of the one or more brands.

17. The system of claim 16, further comprising:
responsive to determining that the sum of squared errors from the calculating is greater than a preconfigured limit, updating the parameters to new parameters in order to minimize the calculated sum of squared errors, indicating that the brand equity may be more accurately estimated pursuant to the historic sales data from the inputs; and
iterating the evaluating the brand value, the estimating the brand equity, and the calculating the sum of squared errors, by use of the new parameters from the updating the parameters.

18. The system of claim 15, the evaluating the brand value comprising:
calculating a carryover brand value from time (t−1) as a mathematical product of the retention rate of the brand value of the current brand and the brand value of the current brand at time (t−1);
calculating a newly generated brand value as a function of the efficiency of marketing and product reach of the current brand, the sensitivity of the current brand to the marketing spend, the marketing data of the current brand, and the reach estimates of the current brand; and
calculating the brand value at time t by adding the carryover brand value and the newly generated brand value.

19. The system of claim 18, wherein the evaluating the brand value utilizes a formula Vᵢ(t+1)=γVᵢ(t)+A×(M(t))^{η}(S(t))^{1-η}, wherein Vᵢ(t+1) represents the brand value of the current brand i at time (t+1), γVᵢ(t) represents the carryover brand value from time t, and A×(M(t))^{η}(S(t))^{1-η} represents the newly generated brand value at time t.

20. The system of claim 15, the estimating the brand equity comprising:
calculating the brand equity as a ratio of the evaluated brand value of the current brand at time t to a sum of brand values at time t estimated for respective brand in the one or more brands, wherein the estimating the brand equity utilizes a formula
$${E}_{i} ( t ) = \frac{{{V}_{i} ( t )}^{{α}_{i}}}{{Σ}_{j} {{V}_{j} ( t )}^{{α}_{j}}} ,$$
wherein Vᵢ(t)^{α}^{ᵢ} represents the evaluated brand value of the current brand at time t to the αᵢ-th power, and ΣⱼVⱼ(t)^{α}^{ⱼ} represents the sum of estimated brand values to the αⱼ-th power at time t for respective brands in the one or more brands.
